(19) United States
(12) Patent Application Publication
(10) Pub. No.: US 2022/0170572 A1
(43) Pub. Date: Jun. 2, 2022

(54) Sewage Hose Covering Device

(71) Applicants: Larry Heib, Warren, OH (US); Cindy Heib, Warren, OH (US)

(72) Inventors: Larry Heib, Warren, OH (US); Cindy Heib, Warren, OH (US)

(21) Appl. No.: 17/109,543

(22) Filed: Dec. 2, 2020

(51) Int. Cl. F16L 3/26; F16L 3/12

(52) U.S. Cl. CPC F16L 3/26; E03F 1/008; F16L 3/1211

(57) ABSTRACT

A sewage hose covering device for shielding a sewage hose of a recreational vehicle from view includes a tube, which is sized so that a sewage hose extending from a recreational vehicle is insertable thereinto. The sewage hose is engaged to an inground sewer connection to direct sewage from the recreational vehicle to an inground sewer. The tube is shields the sewage hose from view.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to covering devices and more particularly pertains to a new covering device for shielding a sewage hose of a recreational vehicle from view. The present invention discloses a cover for covering a sewage hose extending from a recreational vehicle that shields that sewage hose from view.

### (2) Description of Related Art Including Information Disclosed Under 37 CFR 1.97 and 1.98

The prior art relates to covering devices. Prior art covering devices may comprise housings for sewage hoses that fix the sewage hoses in desired configurations. The prior art also may comprise sewage hoses and supports therefor that fix the sewage hoses in desired configurations. What is lacking in the prior art is a cover for a sewage hose that shields that sewage hose from view.

### BRIEF SUMMARY OF THE INVENTION

An embodiment of the disclosure meets the needs presented above by generally comprising a tube, which is sized such that the tube is configured for insertion of a sewage hose extending from a recreational vehicle. The sewage hose is engaged to an inground sewer connection to direct sewage from the recreational vehicle to an inground sewer. The tube is configured to shield the sewage hose from view.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a sewage hose covering device according to an embodiment of the disclosure.

FIG. 2 is a detail view of an embodiment of the disclosure in a closed configuration.

FIG. 3 is a detail view of an embodiment of the disclosure in an open configuration.

FIG. 4 is a cross-sectional view of an embodiment of the disclosure in a closed configuration.

FIG. 5 is a cross-sectional view of an embodiment of the disclosure in an open configuration.

FIG. 6 is a front view of an embodiment of the disclosure.

FIG. 7 is a front view of an embodiment of the disclosure.

FIG. 8 is an in-use view of an embodiment of the disclosure.

### DETAILED DESCRIPTION OF THE INVENTION

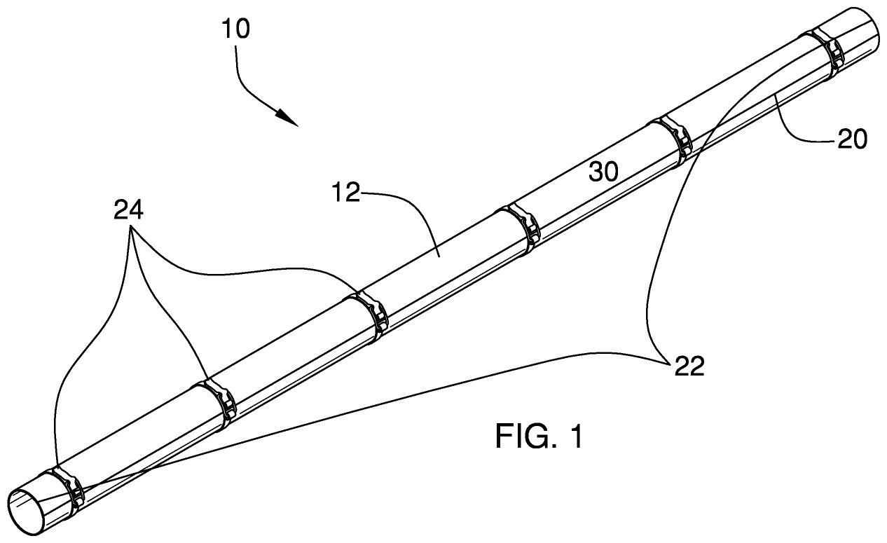

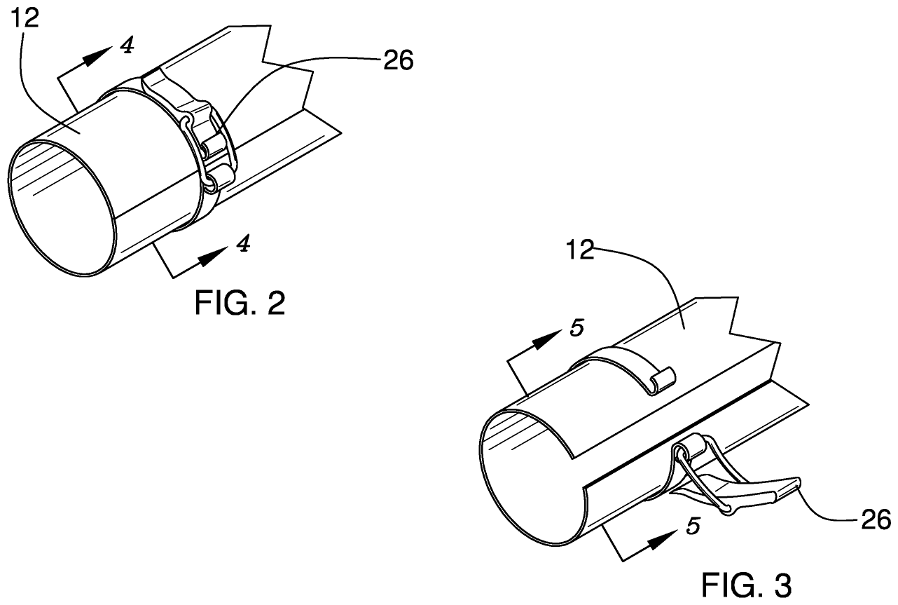

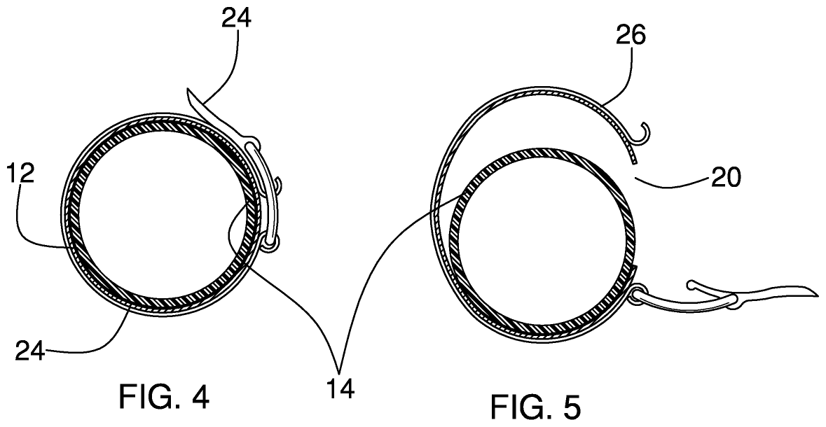

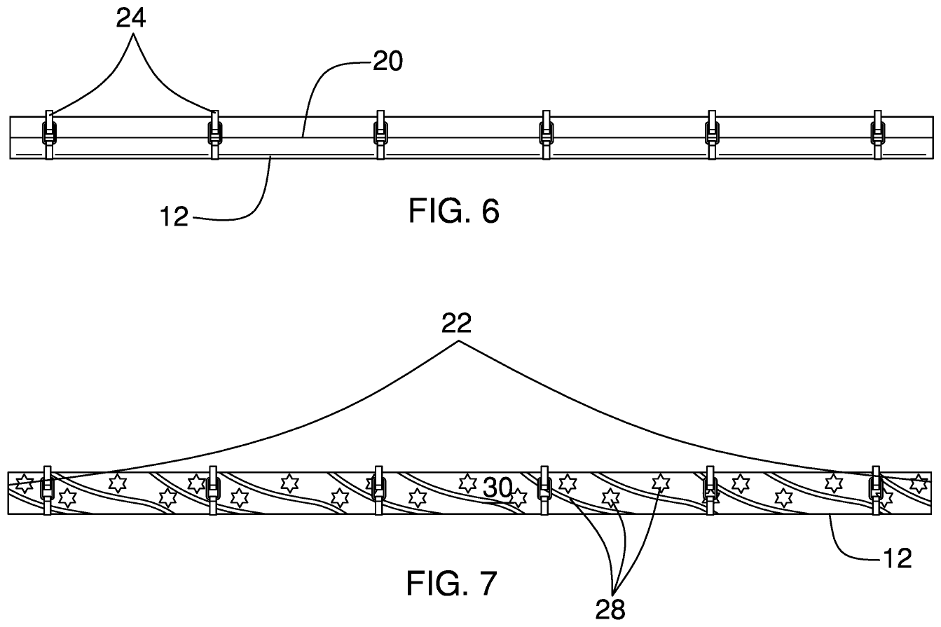

With reference now to the drawings, and in particular to FIGS. 1 through 8 thereof, a new covering device embodying the principles and concepts of an embodiment of the disclosure and generally designated by the reference numeral 10 will be described.

As best illustrated in FIGS. 1 through 8, the sewage hose covering device 10 generally comprises a tube 12, which is sized such that the tube 12 is configured for insertion of a sewage hose 14 extending from a recreational vehicle 16. The sewage hose 14 is engaged to an inground sewer connection 18 to direct sewage from the recreational vehicle 16 to an inground sewer. The tube 12 is configured to shield the sewage hose 14 from view.

The tube 12 has a slit 20 positioned therein and extending between opposed ends 22 thereof. The slit 20 is configured for insertion of the sewage hose 14 therethrough into the tube 12. A set of fasteners 24 configured for positioning around the tube 12 to attach the tube 12 to the sewage hose 14. Each fastener 24 may comprise a quick lock tubing clamp 26, as shown in FIGS. 3-5, or other fastening means, such as, but not limited to, hook and loop fastening straps, worm gear clamps, and the like.

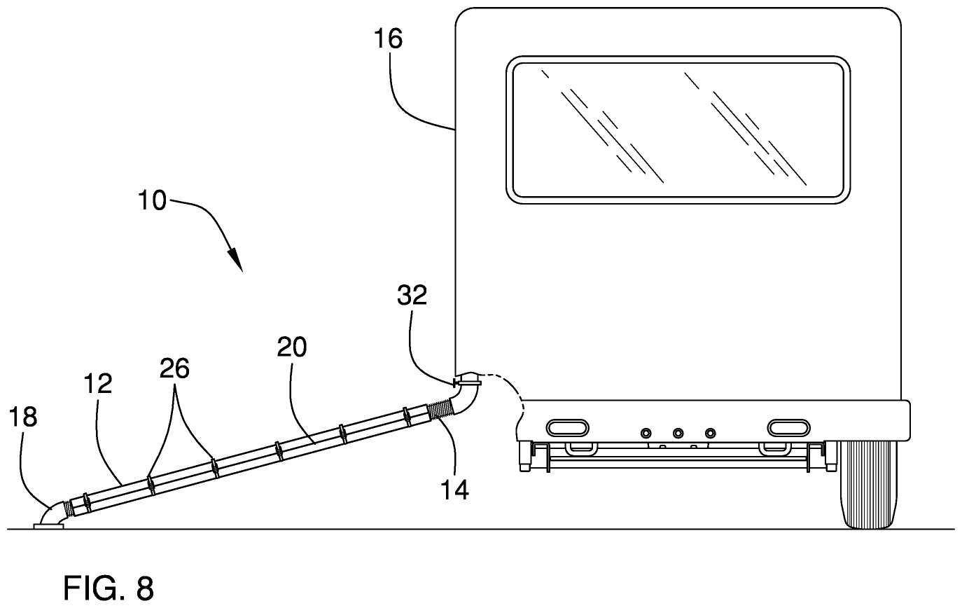

The tube 12 comprises elastomer. The tube 12 may comprise nylon. The sewage hose 14 typically comprises corrugated polyvinyl chloride so that the sewage hose 14 is selectively length adjustable. With the tube 12 comprising nylon, it can remain on the sewage hose 14 when the sewage hose 14 is compressed from an extended configuration, as shown in FIG. 8, to a compacted configuration (not shown).

Indicia 28 may be positioned on an exterior surface 30 of the tube 12, an example of which is shown in FIG. 7. The indicia 28 are configured to improve an appearance of the tube 12 relative to the tube 12 lacking the indicia 28. The indicia 28 may comprise logos, designs, images, and the like.

In use, the sewage hose 14 is engaged to a dump valve 32 on the recreational vehicle 16 and then extended to the inground sewer connection 18 and connected thereto. The tube 12 then is positioned around the sewage hose 14 by inserting the sewage hose 14 through the slit 20. Respective fasteners 24 of the set of fasteners 24 then are used to secure the tube 12 to the sewage hose 14. The tube 12 conceals the sewage hose 14, which typically would comprise unsightly corrugated PVC, from view.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. (canceled)

2. (canceled)

3. (canceled)

4. (canceled)

5. (canceled)

6. (canceled)

7. A sewage hose covering system comprising:
a sewage hose engaged to and extending between dump valve of a recreational vehicle and an inground sewer connection;
a tube sized complementarily to the sewage hose and positioned therearound, wherein the tube is configured for shielding the sewage hose from view, the tube having a constant thickness around a circumference of the tube and being flexible around the circumference of the tube, the tube having a slit positioned therein, the slit extending between opposed ends of the tube wherein the slit extends a full length of the tube, the slit being positioned for insertion of the sewage hose therethrough into the tube; and
a set of fasteners configured for being positioned around the tube for attaching the tube to the sewage hose, wherein each fastener comprises a quick lock tubing clamp, each of the quick lock tubing clamps having an equal diameter when in a closed position, each of the quick lock tubing clamps having a partial loop and a lever coupled to a first end of the partial loop, the lever being selectively engageable to a second end of the partial loop such that pivoting of the lever closes the quick lock tubing clamp, each quick lock tubing clamp being positioned on the tube such that the tube is secured to have a consistent diameter along a full length of the tube when the quick lock tubing clamps are in the closed position.

8. (canceled)

9. The sewage hose covering system of claim 7, wherein the tube comprises elastomer.

10. The sewage hose covering system of claim 9, wherein the tube comprises nylon.

11. (canceled)

12. The sewage hose covering system of claim 7, further including indicia positioned on an exterior surface of the tube, wherein the indicia are configured for improving an appearance of the tube relative to a tube lacking the indicia.

13. A sewage hose covering system comprising:
a sewage hose engaged to and extending between dump valve of a recreational vehicle and an inground sewer connection;
a tube sized complementarily to the sewage hose wherein the tube is configured for shielding the sewage hose from view, the tube having a constant thickness around a circumference of the tube and being flexible around the circumference of the tube, the tube having a slit positioned therein, the slit extending between opposed ends of the tube wherein the slit extends a full length of the tube, the slit being positioned for insertion of the sewage hose therethrough into the tube, the tube comprising elastomer, the tube comprising nylon;
a set of fasteners configured for being positioned around the tube for attaching the tube to the sewage hose, each fastener comprising a quick lock tubing clamp, each of the quick lock tubing clamps having an equal diameter when in a closed position, each of the quick lock tubing clamps being positioned on the tube such that the tube is secured to have a consistent diameter along a full length of the tube when the quick lock tubing clamps are in the closed position, each of the quick lock tubing clamps having a partial loop and a lever coupled to a first end of the partial loop, the lever being selectively engageable to a second end of the partial loop such that pivoting of the lever closes the quick lock tubing clamp; and
indicia positioned on an exterior surface of the tube, wherein the indicia are configured for improving an appearance of the tube relative to the tube lacking the indicia.
